(19) United States
(12) Patent Application Publication
(10) Pub. No.: US 2024/0271744 A1
(43) Pub. Date: Aug. 15, 2024

(54) ADJUSTMENT COMPONENT AND MULTI-FUNCTIONAL TV BRACKET

(71) Applicant: WEIPING CAI, Guangzhou (CN)

(72) Inventor: WEIPING CAI, Guangzhou (CN)

(21) Appl. No.: 18/220,873

(22) Filed: Jul. 12, 2023

(30) Foreign Application Priority Data
Feb. 15, 2023 (CN) 202320220846.0

(51) Int. Cl. F16M 11/18; F16M 11/04; F16M 11/08; F16M 11/10; F16M 13/02

(52) U.S. Cl. CPC F16M 11/18; F16M 11/048; F16M 11/08; F16M 11/10; F16M 13/02

(57) ABSTRACT

The present application discloses an adjustment component, comprising: adjusting members, which includes a screw rod and a washer arranged at one end of the screw rod; a fixed seat with an adjustable seat mounted thereon, when the screw rod is assembled onto the fixed seat, the washer comes into contact with the rear surface of the adjustable seat. The present application also discloses a multi-functional TV bracket, including a fixed plate, wherein the fixed plate is equipped with a linkage component, and the linkage component is connected to the fixed seat. A front end surface of the adjusting seat is provided with an installation bracket through a connecting component, and the installation bracket is mounted on a connecting frame, and this structure is convenient for adjusting the front and rear positions and pitching angles of the TV.

### TECHNICAL FIELD

The present application relates to the technical field of adjustment components and multi-functional TV brackets, specifically a multi-functional TV bracket.

### BACKGROUND

TV brackets are peripheral devices designed for wall mounting of flat-panel TVs and LCD TVs. They are suitable for various locations such as living rooms, bedrooms, offices, conference halls, exhibition halls, hotels, airports, train stations, hospitals, bus stations, shopping malls, etc. They enable the adjustment of the angle of the TV head. However, existing TV head brackets typically employ a waist groove structure for angle adjustment. The angle plate of the waist groove structure has arc grooves on both upper ends and a rotation axis hole at a lower end. The TV is adjusted to the desired pitch angle position by rotating it up and down, and then securing the angle by tightening screws and nuts to fix the angle of inclination using frictional force. However, for heavier TVs, the lateral frictional force may not be sufficient, resulting in the TV tilting to the maximum angle. Furthermore, existing TV brackets have limited functionality, with some only allowing adjustment of the pitch angle, while others only allow adjustment in the horizontal direction. In view of this, we propose an adjustment component and multi-functional TV bracket.

### SUMMARY OF INVENTION

The technical problem to be solved by the present application is to overcome the existing defects and provide an adjustment component and multi-functional TV bracket that facilitates adjustment of the TV's front-to-back position and vertical pitch angle. After adjustment, it can support the pitch angle position of the TV, making the fixation of the pitch angle position more stable, and ensuring horizontal installation of the TV. This can effectively solve the problems mentioned in the background.

To achieve the above purpose, the present application provides the following technical solution:

An adjustment component for adjusting an angle of an installation object, comprising: a fixed seat, an adjustable seat, movably arranged on the fixed seat and used to fix the installation object, two vertically arranged adjusting members, movably arranged on the fixed seat and in contact with the adjustable seat, the two vertically arranged adjusting members are movable, causing the adjustable seat to tilt relative to the fixed seat and be fixed at different angles.

Furthermore, the fixed seat including a top wall, a bottom wall, and an intermediate connecting wall connecting the top wall and the bottom wall, the top wall and the bottom wall of the fixed seat each have an insert plate vertically mounted, the insert plate has a threaded hole, each of the two vertically arranged adjusting members includes a screw rod that extends through the threaded hole, and the intermediate connecting wall of the fixed seat rotatably connects to the adjustable seat.

Furthermore, each of the two vertically arranged adjusting members includes a screw rod and a washer arranged at one end of the screw rod, the screw rod includes a threaded section, a connecting portion connected to one end of the threaded section with a smaller diameter, and a stop portion connected to the connecting portion with a larger diameter, and the washer is mounted on the connecting portion.

Furthermore, the washer is bowl-shaped and includes a rim and a bottom, an opening is formed on the bottom, and a diameter of the opening is larger than a diameter of the connecting portion and smaller than a diameter of the stop portion.

Furthermore, further comprising: a flat washer mounted on the connecting portion, and the flat washer is positioned between the washer and the threaded section.

This application discloses multi-functional TV bracket, including the adjusting component according to any one of claims 1 to 5, comprising: a fixed plate, the fixed plate is equipped with a linkage component, and the linkage component is connected to the fixed seat; a front end surface of the adjusting seat is provided with an installation bracket through a connecting component; and the installation bracket is mounted on a connecting frame. This structure facilitates the adjustment of the front and rear positions and pitch angles of the TV. After adjustment, it can also support the pitch angle position of the TV, making it more stable to fix the pitch angle position of the TV.

Furthermore, the linkage component includes two sets of first lever arms pivotally connected to the fixed plate, and each of the two sets of first lever arms has a second lever arm at an end, and ends of the two second lever arms are connected to the fixed seat.

Furthermore, it further includes installation bars respectively arranged at two ends of the connecting frame, an upper end sidewall of the installation bars has a latch to engage with an upper end of the connecting frame; a lower end of the installation bars is fixedly secured to a lower end of the connecting frame with a U-shaped clip plate; and a front end surface of the installation bars has multiple hanging holes, facilitate the fixed installation of the TV.

Furthermore, each of the two sets of first lever arms includes two first lever arms arranged parallel to each other, the fixed plate is pivotally connected to the two first lever arms, a connecting column is pivotally arranged between ends of the two first lever arms, the connecting column is connected to the second lever arms, and ends of the second lever arms are connected to the fixed seat.

Furthermore, the adjusting seat has arc-shaped grooves located at four corners, the connecting component includes a fixed nut and a fixed bolt, the installation bracket has circular holes corresponding to the arc-shaped grooves, the fixed bolt sequentially extends through the circular holes and the arc-shaped grooves, and the fixed bolt is connected to the fixed nut located at a rear end surface of the adjusting seat, enable to compensate and level the installation bracket.

Compared to the prior art, the advantageous effects of the present application are as follows:
1. By rotating the screw rod head to adjust the contact distance between the adjustment component in the top and bottom wall insert plates of the fixed seat and the adjusting seat, the pitch angle of the supported object (such as a TV) can be indirectly adjusted.
2. The washer is flexibly positioned on the connecting portion, limiting its movement and rotation within a certain range (the connecting portion). This allows the washer to provide support to the adjusting seat at any angle of the supported object (such as a TV).
3. The protrusions on the fixed seat are accommodated by the protrusions on the adjusting seat. The combination of these two triangular structures with the adjustment component not only enables forward and backward rotation but also enhances the stability of the adjustment structure.
4. The loosened screws connecting the fixed plate and the first lever arm, the first lever arm and the second lever arm, and the second lever arm and the fixed seat can push and pull the first and second lever arms, allowing for free adjustment of the TV's front-to-back position and left-to-right tilt angle. After adjustment, tighten the bolts connecting the fixed plate and the first lever arm, the bolts connecting the first lever arm and the second lever arm, and the bolts connecting the second lever arm and the fixed seat to limit and fix the first lever arm and the second lever arm.
5. Loosening the fixed nut at a rear end of the fixed screw allows the inclined setting of the arc groove to move the fixed screw within the arc groove, thereby compensating and leveling the installation bracket. Once the installation bracket is leveled, tightening the fixed nut secures the bracket, enabling a certain level of compensation adjustment.

### BRIEF DESCRIPTION OF DRAWINGS

FIG. 1 is a schematic diagram of the combined structure of the adjustment components in one embodiment of the present application.

FIG. 2 is a schematic diagram of the combined structure of the adjustment components of the present application.

FIG. 3 is a schematic diagram of the disassembled structure of a multifunctional TV bracket of the present application.

FIG. 4 is an enlarged structural schematic diagram of location A in the multifunctional TV bracket of the present application.

FIG. 5 is a schematic diagram of the combined structure of the multifunctional TV bracket of the present application.

FIG. 6 is a schematic diagram of another angle of the combined structure of the multifunctional TV bracket of the present application.

### DETAILED DESCRIPTION

The present application will be described in detail with reference to the accompanying drawings of the embodiments of the present application. It is apparent that the embodiments described herein are only a part of the embodiments of the present application, not all embodiments. Based on the embodiments of the present application, all other embodiments obtained by those skilled in the art without creative labor are within the scope of protection of the present application.

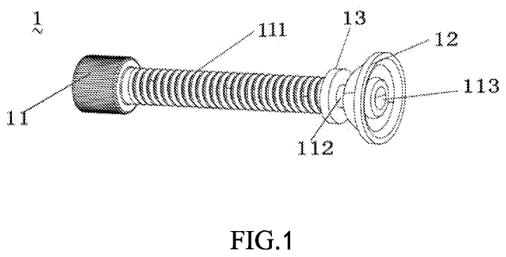

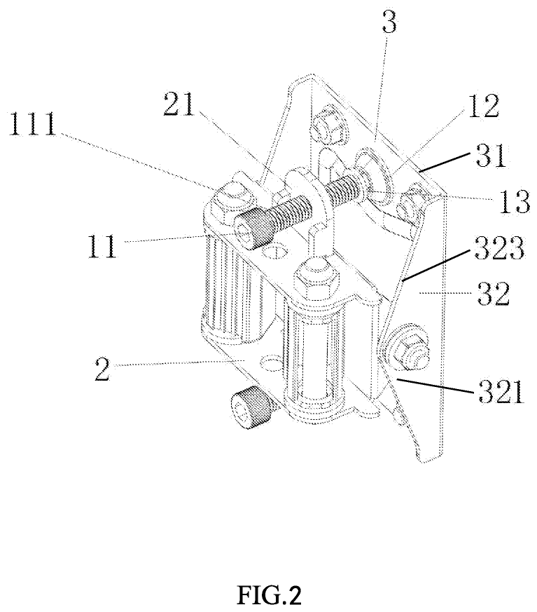

As shown in FIGS. 1 and 2, the present application provides an adjustment component, including at least one adjustment member 1 (in this embodiment, there are two adjustment members arranged vertically). Each adjustment member 1 includes a screw rod 11 and a washer 12 arranged at one end of the screw rod 11. The screw rod 11 comprises a threaded section 111, a connecting portion 112 connected to one end of the threaded section 111 but with a smaller diameter, and a stop portion 113 connected to the connecting portion 112 but with a larger diameter. The washer 12 is flexibly positioned on the connecting portion 112. The washer 12 is bowl-shaped and includes a rim and a bottom with an opening. The diameter of the opening is larger than the diameter of the connecting portion 112 and smaller than the diameter of the stop portion 113. Due to the smaller opening diameter of the washer 12 compared to the diameter of the stop portion 113, the washer 12 is limited to a certain range of movement and rotation (the connecting portion 112), preventing it from falling off the connecting portion 112.

The adjustment component of the present application further includes a flat washer 13 arranged on the connecting portion 112. The flat washer 13 is positioned between the washer 12 and the threaded section 111, increasing the contact area with the washer 12 and reducing the pressure.

As shown in FIG. 2, there is a fixed seat 2 with an adjustable seat 3 mounted on it. When the screw rod 11 is assembled onto the fixed seat 2, the washer 12 comes into contact with the rear surface of the adjustable seat 3. In this embodiment, the fixed seat 2 includes a top wall 23, a bottom wall 24, and an intermediate connecting wall 25 connecting the top wall 23 and the bottom wall 24. The top wall 23 and the bottom wall 24 are opposing faces that extend vertically from the opposite sides of the connecting wall 25. The fixed seat 2 further includes insertion plates 21 on the top wall 24 and the bottom wall 24, respectively, with threaded holes provided on them. On the other two sides of the connecting wall 25, which do not contact the top wall 23 or the bottom wall 24, there are connecting protrusions 22. These connecting protrusions 22 are triangular in shape, positioned vertically to the connecting wall 25 and extending in a direction away from the top wall 23 and the bottom wall 24.

The screw rod 11 of the adjustment member 1 extends through the threaded hole and is rotatably connected to the adjustable seat 3 through a pin shaft on the middle connecting wall of the fixed seat 2. The adjustable seat 3 comprises a base 31 and protrusions 32 extending vertically from the opposite sides of the base 31. The protrusions 32 are triangular in shape, and at one end away from the base 31, they form a connecting top 321. The protrusions 32 also have inclined surfaces 323 on their sides, and the distance between these inclined surfaces 323 becomes shorter as they move away from the base 31.

The two connecting protrusions 22 are positioned between the two protrusions 32 and are in contact with them. The two connecting protrusions 22 are rotationally connected to the connecting tops 321 of the protrusions 32. Due to the inclined surfaces 323, when the fixed seat 2 rotates relative to the connecting tops 321 of the protrusions 32, the inclined surfaces 323 do not interfere with the movement of the fixed seat 2, allowing it to move freely without obstruction from the adjustable seat 3.

In this embodiment, the triangular shape of the connecting protrusions 22 and the protrusions 32 enhances the stability of the structure. It should be understood that the shapes of the connecting protrusions 22 and the protrusions 32 can be modified according to specific requirements. When using this adjustment component, the screw rod 11 can be rotated at the head to adjust the contact distance between the adjustment member 1 in the insertion plate 21 of the top wall and the bottom wall of the fixed seat 2 and the base 31 of the adjustable seat 3, thereby allowing adjustment of the pitch angle of the adjustable seat 3.

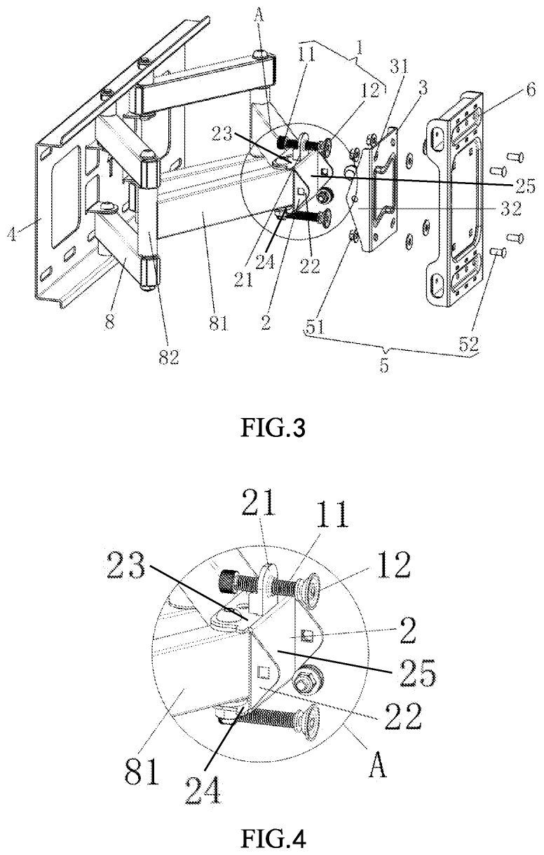

As shown in FIGS. 3 to 6, the present application also provides a multifunctional TV bracket, which includes the adjustment component and further comprises a fixed plate 4. The fixed plate 4 is equipped with a linkage component, which is connected to the fixed seat 2. The front surface of the adjusting seat 3 is provided with an installation bracket 6 through a connecting component 5, and the installation bracket 6 is arranged on a connecting frame 7.

As shown in FIG. 3, the adjusting seat 3 has arc-shaped grooves 31 located at its four corners. The connecting component 5 includes a fixed nut 51 and a fixed bolt 52. The installation bracket 6 has circular holes corresponding to the arc-shaped grooves 31, and the fixed bolt 52 extends through the circular holes and the arc-shaped grooves 31 to connect with the fixed nut 51 located on the rear surface of the adjusting seat 3. When the installed TV is slightly tilted in the horizontal direction, you only need to loosen the fixed nuts 51 at a rear end of the four fixed bolts 52. Due to the inclined setting of the arc-shaped grooves 31, the fixed bolts 52 can be moved within the arc-shaped grooves 31 to compensate and level the installation bracket 6. After the installation bracket 6 is leveled, tighten the fixed nuts 51 to secure the installation bracket 6, indirectly achieving leveling of the TV.

By adjusting the two vertically arranged adjusting components 1, connecting protrusion 22, and protrusion 32, different angles can be achieved. It not only allows forward tilt rotation but also backward tilt rotation. Moreover, while adjusting, the connecting protrusion 22, washer 12, and screw rod 11 can further fix the pitch position, making the adjustment structure more stable.

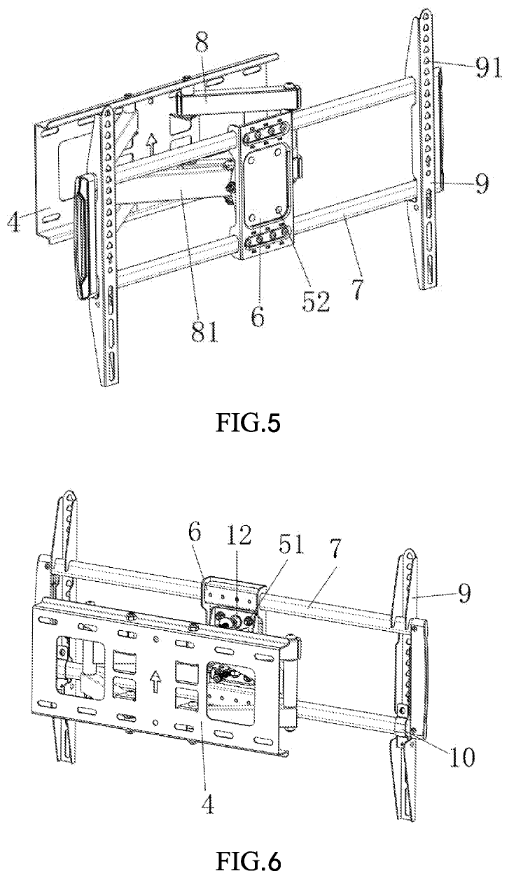

As shown in FIGS. 3 and 5, the linkage component includes two sets of first lever arms 8 that are rotatably connected to the fixed plate 4, and each of the two sets of first lever arms 8 has a second lever arm 81 pivotally mounted at the other end. The ends of the two second lever arms 81 are connected to the fixed seat 2. In this embodiment, each of the two sets of first lever arms 8 includes two first lever arms 8 set in parallel vertically. The fixed plate 4 is pivotally connected to the first lever arms 8 (such as through bolts) so that the first lever arms 8 can rotate relative to the fixed plate 4 using the bolts as the pivot axis. A connecting column 82 is pivotally mounted between the other ends of the two first lever arms 8 using bolts, and the connecting column 82 is connected to the second lever arm 81. The ends of the two second lever arms 81 are connected to the fixed seat 2. By loosening the bolts that connect the fixed plate 4 and the first lever arms 8, the bolts that connect the first lever arms 8 and the second lever arms 81, and the bolts that connect the second lever arms 81 and the fixed seat 2, the first lever arms 8 and the second lever arms 81 can be pushed and pulled, indirectly allowing free adjustment of the forward and backward positions and the left and right tilt angles of the supported object (such as a TV). After adjustment, tighten the bolts that connect the fixed plate 4 and the first lever arms 8, the bolts that connect the first lever arms 8 and the second lever arms 81, and the bolts that connect the second lever arms 81 and the fixed seat 2 to limit and fix the first lever arms 8 and the second lever arms 81.

The present application of a multifunctional TV bracket further includes installation bars 9 that are respectively arranged at two ends of the connecting frame 7. A upper sidewall of the installation bars 9 is equipped with a latch for engaging with a upper end of the connecting frame 7, while a lower end of the installation bars 9 is firmly fixed to a lower end of the connecting frame 7 through a U-shaped clip plate 10. The front surface of the installation bars 9 is provided with multiple hanging holes 91. The latch at a upper end of the installation bars 9 engages with a upper end of the connecting frame 7, and then a lower end of the installation bars 9 is connected and fixed to the connecting frame 7 using the U-shaped clip plate 10. This securely connects the installation bars 9 with the connecting frame 7. The TV can be fixed to the installation bars 9 using the hanging holes 91, facilitating the secure installation of the TV.

The working principle of the multifunctional TV bracket of the present application is as follows:
1. Since the adjusting seat 3 and the fixed seat 2 are connected through a pin shaft, when it is necessary to adjust the pitch angle of the supported object (such as a TV), it is only required to rotate the head of the screw rod 11 to adjust the contact distance between the adjusting component 1 in the top wall and bottom wall insert plate 21 of the fixed seat 2, thereby adjusting the pitch angle of the adjusting seat 3. Additionally, since the installation bracket 6 is set on the adjusting seat 3, and the installation bracket 6 is arranged on the connecting frame 7, which is equipped with the installation bars 9, the TV is mounted on the installation bars 9. Therefore, when adjusting the pitch angle of the adjusting seat 3, the TV can be indirectly adjusted in its pitch position. Furthermore, the washer 12 is pivotally mounted on the connecting portion 112, limiting its movement and rotation within a certain travel range. This ensures that the washer 12 can support the adjusting seat 3 when the supported object (such as a TV) is at any angle, thereby providing stable support for the adjusted pitch angle of the TV.
2. If it is necessary to adjust the front-to-back position and the left-to-right tilt angle of the TV, simply loosen the screws connecting the fixed plate 4 and the first lever arm 8, the screws connecting the first lever arm 8 and the second lever arm 81, and the screws connecting the second lever arm 81 and the fixed seat 2. This allows for the extension or retraction of the first lever arm 8 and the second lever arm 81, indirectly enabling the adjustment of the front-to-back position and the left-to-right tilt angle of the TV. After adjustment, tighten the screws connecting the fixed plate 4 and the first lever arm 8, the screws connecting the first lever arm 8 and the second lever arm 81, and the screws connecting the second lever arm 81 and the fixed seat 2 to limit and secure the positions of the first lever arm 8 and the second lever arm 81.
3. Use screws to secure the fixed plate 4 to the appropriate position on the wall through the mounting hole. Assemble the TV on the installation bars 9. If the assembled TV is slightly tilted, loosen the fixed nuts 51 at the ends of the four fixed bolts 52. Due to the inclined arrangement of the arc grooves 31, the fixed bolts 52 can move within the arc grooves 31 to compensate and level the installation bracket 6. Once the installation bracket 6 is leveled, tighten the fixed nuts 51 to secure the installation bracket 6, thereby achieving horizontal positioning of the TV.

The above description is only an embodiment of the present application and does not limit the scope of the invention. Equivalent structures or equivalent process transformations made based on the content of the present application specification and drawings, or their direct or indirect application in other relevant technical fields, are also included within the scope of the patent protection of the present application.

1. An adjustment component for adjusting an angle of an installation object, comprising:
a fixed seat,
an adjustable seat, movably arranged on the fixed seat and used to fix the installation object,
two vertically arranged adjusting members, movably arranged on the fixed seat and in contact with the adjustable seat,
the two vertically arranged adjusting members are movable, causing the adjustable seat to tilt relative to the fixed seat and be fixed at different angles.

2. The adjusting component according to claim 1, wherein:
the fixed seat including a top wall, a bottom wall, and an intermediate connecting wall connecting the top wall and the bottom wall, the top wall and the bottom wall of the fixed seat each have an insert plate vertically mounted, the insert plate has a threaded hole, each of the two vertically arranged adjusting members includes a screw rod that extends through the threaded hole, and the intermediate connecting wall of the fixed seat rotatably connects to the adjustable seat.

3. The adjusting component according to claim 1, wherein:
each of the two vertically arranged adjusting members includes a screw rod and a washer arranged at one end of the screw rod, the screw rod includes a threaded section, a connecting portion connected to one end of the threaded section with a smaller diameter, and a stop portion connected to the connecting portion with a larger diameter, and the washer is mounted on the connecting portion.

4. The adjusting component according to claim 3, wherein:
the washer is bowl-shaped and includes a rim and a bottom, an opening is formed on the bottom, and a diameter of the opening is larger than a diameter of the connecting portion and smaller than a diameter of the stop portion.

5. The adjusting component according to claim 3, further comprising:
a flat washer mounted on the connecting portion, and the flat washer is positioned between the washer and the threaded section.

6. A multi-functional TV bracket, including the adjusting component according to claim 1, comprising:
a fixed plate, the fixed plate is equipped with a linkage component, and the linkage component is connected to the fixed seat; a front end surface of the adjusting seat is provided with an installation bracket through a connecting component; and the installation bracket is mounted on a connecting frame.

7. The multi-functional TV bracket according to claim 6, wherein:
the linkage component includes two sets of first lever arms pivotally connected to the fixed plate, and each of the two sets of first lever arms has a second lever arm at an end, and ends of the two second lever arms are connected to the fixed seat.

8. The multi-functional TV bracket according to claim 6, further comprising:
installation bars respectively arranged at two ends of the connecting frame, an upper end sidewall of the installation bars has a latch to engage with an upper end of the connecting frame; a lower end of the installation bars is fixedly secured to a lower end of the connecting frame with a U-shaped clip plate; and a front end surface of the installation bars has multiple hanging holes.

9. The multi-functional TV bracket according to claim 7, wherein:
each of the two sets of first lever arms includes two first lever arms arranged parallel to each other, the fixed plate is pivotally connected to the two first lever arms, a connecting column is pivotally arranged between ends of the two first lever arms, the connecting column is connected to the second lever arms, and ends of the second lever arms are connected to the fixed seat.

10. The multi-functional TV bracket according to claim 6, wherein:
the adjusting seat has arc-shaped grooves located at four corners, the connecting component includes a fixed nut and a fixed bolt, the installation bracket has circular holes corresponding to the arc-shaped grooves, the fixed bolt sequentially extends through the circular holes and the arc-shaped grooves, and the fixed bolt is connected to the fixed nut located at a rear end surface of the adjusting seat.
